(19) United States
(12) Patent Application Publication
(10) Pub. No.: US 2026/0301144 A1
(43) Pub. Date: Oct. 1, 2026

(54) NON-LINEAR MVU FILTERING FOR DIGITAL TWINNING

(71) Applicant: University of New Hampshire, Durham, NH (US)

(72) Inventors: Saeed EFTEKHAR AZAM, Medford, MA (US); Mohsen Ebrahimzadeh HASSANABADI, Penrith (AU); Martin Masanes DIDYK, Dover, NH (US); Daniel LINZELL, Lincoln, NE (US)

(21) Appl. No.: 19/576,138

(22) Filed: Mar. 24, 2026

Related U.S. Application Data
(60) Provisional application No. 63/776,612, filed on Mar. 24, 2025.

(51) Int. Cl. G06T 7/00

(52) U.S. Cl. CPC G06T 7/0002; G06T 2207/30184

(57) ABSTRACT

Systems and methods for applying non-linear minimum variance unbiased filtering for digital twinning in systems without direct feedthrough and unknown load information. In one example a method includes acquiring, with a camera, a plurality of images of a structure, deriving, from the plurality of images and by using computer vision analysis, a time-sequence of measurements of the structure to produce input data, and applying a non-linear minimum variance unbiased filter to the input data to generate an estimate of at least one parameter of the structure.

### CROSS-REFERENCE TO RELATED APPLICATIONS

This application claims priority under 35 U.S.C. § 119(e) to U.S. Provisional Patent Application No. 63/776,612 titled “NON-LINEAR MINIMUM VARIANCE UNBIASED FILTERING FOR DIGITAL TWINNING IN SYSTEMS WITHOUT DIRECT FEEDTHROUGH MATRIX AND UNKNOWN LOAD INFORMATION” and filed on Mar. 24, 2025, which is hereby incorporated herein by reference in its entirety for all purposes.

### FIELD OF THE DISCLOSURE

The present disclosure relates generally to modeling and monitoring of structures.

### BACKGROUND

The concept of digital twinning involves creating a digital replica of a system from which it is possible to extract information that accurately represents what is happening in the real system. Interactions with the digital replica can be used to analyze and interpret conditions in a physical counterpart. For infrastructure applications, the characteristics of the digital twin, and therefore its usefulness in modeling the real system, depend on whether the digital twin accurately represents the structural behavior and/or mechanical components of the real system. Kalman filters are used in some digital twinning applications.

### SUMMARY

Although Kalman-type filters are used in some digital twinning applications, Kalman-type filters need input information, which is often unknown or unavailable in real-world structural systems. As a result, it can be difficult to model and predict system behavior. Furthermore, existing approaches to building twinning systems face limitations in their ability to handle non-linear systems and/or diverse sensor data, such as displacement, rotations, strain, and/or velocity. Thus, a number of non-trivial challenges remain for digital twinning applications.

Accordingly, certain aspects and examples are directed to a non-linear extension of a minimum variance unbiased filter that can be applied to digital twinning applications. In some examples, computer vision, or other non-contact sensor techniques, can be used to supply the measurement data used in system analysis, thus eliminating the need for contact sensors and offering a flexible approach that can be applied to a diverse range of environments and conditions.

In one example, a method comprises acquiring, with a camera, a plurality of images of a structure; deriving, from the plurality of images and by using computer vision analysis, a time-sequence of measurements of the structure to produce input data; and applying a non-linear minimum variance unbiased filter to the input data to generate an estimate of at least one parameter of the structure. In some instances, the measurements are displacement and/or velocity measurements, and the at least one parameter is a stiffness of the structure.

Numerous additional examples and variations will be apparent in light of the present disclosure.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### BRIEF DESCRIPTION OF THE DRAWINGS

FIG. 1 is a block diagram of a system for digital twinning in accordance with aspects of the disclosed technology.

FIG. 2 is a flow diagram of a non-linear minimum variance unbiased filtering methodology, in accordance with aspects of the disclosed technology.

FIG. 3 is a diagram illustrating a building used for simulations and experimental validation of an example of a non-linear minimum variance unbiased filtering method in accordance with aspects of the disclosed technology.

FIG. 4 is a graph showing a ground acceleration spectrum (acceleration as a function of time) used for simulations of an example of a non-linear MVU filter applied to the building of FIG. 3, in accordance with aspects of the disclosed technology.

FIG. 5 is a graph showing simulated normalized stiffness estimations as a function of time, in accordance with aspects of the disclosed technology.

FIG. 6 is an illustration of a bolted connection used in a laboratory-scale construction of the building of FIG. 3.

FIG. 7 is a graph showing a ground acceleration spectrum (acceleration as a function of time) used for experiments involving the laboratory-scale construction of the building of FIG. 3, in accordance with aspects of the disclosed technology.

FIG. 8A is a graph illustrating absolute displacement as a function of time for the first floor of the test building, in accordance with aspects of the disclosed technology.

FIG. 8B is a graph illustrating absolute displacement as a function of time for the second floor of the test building, in accordance with aspects of the disclosed technology.

FIG. 8C is a graph illustrating absolute displacement as a function of time for the third floor of the test building, in accordance with aspects of the disclosed technology.

FIG. 8D is a graph illustrating absolute displacement as a function of time for the fourth floor of the test building, in accordance with aspects of the disclosed technology.

FIG. 8E is a graph illustrating absolute displacement as a function of time for the fifth floor of the test building, in accordance with aspects of the disclosed technology.

FIG. 8F is a graph illustrating absolute displacement as a function of time for the sixth floor of the test building, in accordance with aspects of the disclosed technology.

FIG. 9 is a graph illustrating ground displacement as a function of time, in accordance with aspects of the disclosed technology.

FIG. 10A is a graph illustrating relative displacement as a function of time for the first floor of the test building, in accordance with aspects of the disclosed technology.

FIG. 10B is a graph illustrating relative displacement as a function of time for the second floor of the test building, in accordance with aspects of the disclosed technology.

FIG. 10C is a graph illustrating relative displacement as a function of time for the third floor of the test building, in accordance with aspects of the disclosed technology.

FIG. 10D is a graph illustrating relative displacement as a function of time for the fourth floor of the test building, in accordance with aspects of the disclosed technology.

FIG. 10E is a graph illustrating relative displacement as a function of time for the fifth floor of the test building, in accordance with aspects of the disclosed technology.

FIG. 10F is a graph illustrating relative displacement as a function of time for the sixth floor of the test building, in accordance with aspects of the disclosed technology.

FIG. 11A is a graph illustrating, for the third floor of the test building, a comparison of power spectral density results obtained from an example of the non-linear MVU filtering process and from the third floor LVDT, in accordance with aspects of the disclosed technology.

FIG. 11B is a graph illustrating, for the fifth floor of the test building, a comparison of power spectral density results obtained from an example of the non-linear MVU filtering process and from the fifth floor LVDT, in accordance with aspects of the disclosed technology; the legend for FIG. 11A also applies to FIG. 11B.

FIG. 12 is a graph showing normalized stiffness estimations as a function of time, in accordance with aspects of the disclosed technology.

The drawings are for the purpose of illustrating examples; however, it will be understood that variations, including different and/or additional aspects and arrangements thereof, are possible, and that the technology disclosed herein is not limited to the arrangements and/or instrumentality shown in the drawings. For purposes of clarity, not every component may be labeled in every drawing. Furthermore, as will be appreciated, the figures are not necessarily drawn to scale or intended to limit the present disclosure to the specific configurations shown.

### DETAILED DESCRIPTION

Techniques are disclosed for applying digital twinning to systems without a direct feedthrough matrix, using an approach that does not rely on prior information about unknown loads or their statistics. Linear systems can be classified as those without direct feedthrough or those with direct feedthrough to the output. In the context of structural dynamics, this classification can be based on the availability of acceleration measurements or lack thereof. As described in more detail below, examples disclosed herein provide a non-linear extension to minimum variance unbiased (MVU) filtering that is tailored to systems without a direct feedthrough matrix. Traditional modeling methods, such as Kalman filters, rely heavily on known input information or statistical information about the inputs, which limits their applicability in real-world structural systems where loads (e.g., wind, earthquakes, etc.) may be unknown and/or unpredictable. In contrast, techniques described herein avoid such limitations by using an MVU filter which simultaneously estimates inputs, states, and system parameters without needing prior knowledge of the input model. Techniques described herein may be highly versatile and can be applied to various sensor networks that measure pure displacement, rotation, strain, and/or velocity, making the approach broadly applicable to digital twinning in diverse engineering systems. Examples of the filtering technique disclosed herein may not only improve the accuracy of state and parameter estimation in non-linear systems, but may also integrate seamlessly with sensor networks, providing a robust and adaptable solution for digital twin development in structural monitoring and other applications.

### General Overview

Digital twinning has utility in a variety of applications and contexts, including large civil infrastructure applications. For example, in structural health monitoring applications, digital twinning can provide information about the real counterpart system that is not readily available due to reasons such as lack of accessibility, costs associated with obtaining data, and/or other factors. However, these applications face numerous challenges, including the challenge of accurately estimating the states, inputs, and system parameters in digital twins of structural systems that lack direct feedthrough matrices. For example, Recursive Bayesian estimation (RBE) combines data from simulations and sensors to estimate system states, but faces challenges in estimating unobserved states. Kalman-type filters need input information, which poses a challenge since, in structural systems, input data and/or loads acting on the systems (e.g., wind, earthquakes, or other environmental conditions) are generally unknown. The used of an augmented Kalman filter attempts to address this issue by assuming a random walk as input model, but still faces challenges and limitations, such as the need for statistical information about the input and the need to tune covariance and hyperparameters (e.g., using an L-curve or a grid search).

Recursive Bayesian estimation may involve simultaneous estimation of inputs, states, and parameters. When the objective is to estimate states and inputs while considering system physics, a model is assumed, and system parameters are assumed to be known. In some instances, this involves the use of a previously calibrated model of the system for the process to provide accurate estimates. However, in many cases the modeling parameters deviate from their true values, particularly in aging infrastructure. To circumvent this issue, system parameters can be estimated by augmenting the state vector with the unknown parameters. However, this augmentation introduces non-linearity into the system equations, as the parameters of the state matrix also become part of the state vector.

In addition, significant challenges in structural health monitoring and system identification applications using recursive Bayesian estimation methods are related to obtaining the measurements used for system modeling and evaluation. For example, there may be challenges associated with determining optimal sensor placement on or around structures being observed, as well as practical constraints in the accessibility and availability of the optimal locations for sensor installation. When dealing with real-life structural systems, obtaining accurate displacement and velocity measurements can be limited and costly. This problem is particularly noticeable when the complexity of the system drives a need for observation of many degrees of freedom. Furthermore, there may be challenges associated with determining the minimum number of available observations required to address stability problems related to rank deficiency of the system model matrices. Thus, numerous non-trivial issues remain with respect to using digital twinning to model complex real-world structures.

To address these and other issues, examples disclosed herein provide an approach to digital twinning that extends minimum variance unbiased (MVU) filtering to non-linear systems and eliminates the need for prior knowledge of unknown inputs, thus making it suitable for a wide range of sensor networks. MVU filters are a class of recursive Bayesian filters that address the input-state problem by estimating the input as part of the filter process. Initially, a biased a-priori state is estimated, which is later corrected into an unbiased a-priori state by estimating the input, and finally state observations are used to correct the initial estimation. An advantage of MVU filters is that input estimation does not depend on prior knowledge about the input model or its statistics. Additionally, MVU-type filters can incorporate processes that reject the input as part of the process equation and rely only on system outputs to estimate the states. It should be noted, however, that even if the input is rejected in the system equations, the input load can be recursively estimated as a by-product of the filter.

Embodiments disclosed herein provide an approach for extending the MVU filter processes to handle non-linear systems. In some examples, a non-linear extension for an MVU filter for systems without direct feedthrough involves calculating the Jacobian of the state function, as described further below. This method can be applied to systems that do not feature the direct feedthrough matrix in their state-space formulation, such as (in the context of structural system identification) those in which pure displacement, tilt, and/or strain measurements are available. Embodiments disclosed herein implement non-contact, distributed sensing methods, and in some examples, provide an approach by which to achieve stochastic structural system identification via computer vision measurements. In particular, certain examples use computer vision techniques to achieve measurements of precise displacement time histories for structural system identification. For example, computer vision techniques can be applied to estimate displacement and velocities of the system, which are then utilized as observations in the non-linear MVU filter. In some examples, computer vision measurements are used to provide a virtual sensor network, thereby removing the need to place contact sensors on the structure to measure variables such as displacement, strain, tilt, etc. In some examples, computer vision analysis can be applied to still or video images of the structure that are acquired using one or more cameras to derive displacement measurements therefrom.

These and other features are described in more detail below.

### System Architecture

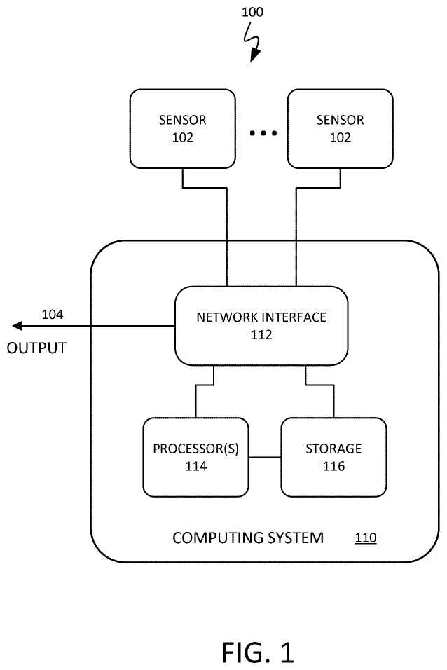

FIG. 1 is a block diagram of a system 100 configurable to implement aspects and examples of the techniques described herein. The system 100 includes a computing system 110 that includes a network interface 112, one or more processors 114, and processor-readable storage 116. The computing system 110 can be coupled to one or more sensors 102 via the network interface 112. The sensors 102 may supply measurement data that is used by the computing system 110 to estimate inputs, states, and/or parameters of a digital twin of a certain structure (e.g., a building or airplane). In some examples, the sensors 102 are physical devices, such as sensors that can be measure strain, displacement, tilt, velocity, or other variables. In other examples, the sensors 102 include one or more cameras that acquire images (still or video) of the structure. These images may be processed by the computing system 110 or another external computing system (not shown) to derive measurement data, such as displacement measurements. For example, computer vision techniques can be used to analyze a video stream, or sequence of images obtained over time, to detect movement of the structure or an observed portion thereof. For example, sway, tilt, settling, twist, or other displacement of a building, or portion thereof, can be measured/observed over time by comparing a time sequence of images of the building taken from the same vantage point. In some examples one or more cameras can be used to acquire images over time from different angles or points of view.

In some examples, the images can be stored in the storage 116 and accessed by the processor(s) 114 for processing. In other examples, the image processing may be performed by another system, and the resulting measurement data can be provided to the computing system 110 and optionally stored in the storage 116. The storage 116 may include volatile and/or non-volatile memory, and/or other types of processor-readable computer storage media. In some examples, the storage 116 stores code describing processes and calculations that, when the code is executed by the processor(s) 114, control the computing system 110 to perform aspects of the non-linear minimum variance unbiased filtering approach described herein.

The processor(s) 114 can be one or more programmable processors to execute one or more executable instructions to control the operations of the computing device 110. As used herein, the term “processor” describes circuitry that executes a function, an operation, or a sequence of operations. The function, operation, or sequence of operations can be hard coded into the circuitry or soft coded by way of instructions held in a memory device (e.g., the storage 116) and executed by the circuitry. In some examples, the processor(s) 114 include a digital processor, but the processor(s) 114 can be analog, digital, or mixed. As such, the processor(s) 114 can execute the function, operation, or sequence of operations using digital values and/or using analog signals. In some examples, the processor(s) 114 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor(s) 114 that are multicore can provide functionality for parallel, simultaneous execution of instructions or for parallel, simultaneous execution of one instruction on more than one piece of data.

The processor(s) 114 execute instructions to perform examples of the non-linear minimum variance filtering approach described herein for digital twinning, and provide an output 104. This output 104 may include an estimate of one or more system inputs, states, and/or parameters, which may be interpreted or further analyzed by a person, the computing system 110, or another computing system.

### Non-Linear MVU Filter

As described above, examples provide an approach for producing a minimum variance unbiased filter that can be applied to non-linear systems, and for using such a filter in digital twinning, or other structural modelling, applications.

a. System Equation

According to certain examples, the following difference equation (Eq. 1) is used to describe the dynamics of a nonlinear system:

$${x}_{k} = {f}_{k - 1} ( {x}_{k - 1} ) + {G}_{k - 1} {d}_{k - 1} + {w}_{k - 1} \qquad ( Eq . 1 )$$

In Equation (1), the system input is denoted by the vector dₖ ∈ [symbol] ^{m}; the a vector, augmented with unknown parameters, is signified by xₖ ∈ [symbol] ⁿ; Gₖ ∈ [symbol] ^{n×m} maps the input vector to the system evolution; fₖ: [symbol] ⁿ→ [symbol] ⁿ is a nonlinear vectorial function; and the modeling error is denoted by the random variable wₖ ∈ [symbol] ⁿ. The following observation equation (Eq. 2) relates noisy measurements yₖ ∈ [symbol] ^{p} to the augmented state vector using the observation matrix Cₖ ∈ [symbol] ^{p×n}:

$${y}_{k} = {C}_{k} {x}_{k} + {v}_{k} \qquad ( Eq . 2 )$$

In Equation (2), measurement noise (or observation/measurement error) is denoted by vₖ ∈ [symbol] ^{p}. The random variables wₖ and vₖ represent zero-mean white noise with zero mutual correlation. The initial estimate of the augmented state vector \hat{x}₀ is unbiased. That is, [symbol] [\hat{x}₀]=x₀, where [symbol] [·] represents the expectation operator. Moreover, \hat{x}₀ is uncorrelated with the modeling and observation errors. The covariance matrices Qₖ and Rₖ characterize the statistics of the noise vectors as follows:

$$𝔼 [ {w}_{i} {w}_{j}^{T} ] = {δ}_{ij} {Q}_{i} \qquad ( Eq . 3 a )$$

$$𝔼 [ {v}_{i} {v}_{j}^{T} ] = {δ}_{ij} {R}_{i} \qquad ( Eq . 3 b )$$

b. Estimation Steps

According to certain examples, non-linear estimation involves four stages, namely, obtaining a biased initial estimate of the augmented state vector, predicting the input vector, obtaining an unbiased estimate of the augmented state vector, and completing the state estimation. In one example, in the first stage, the biased initial estimate of the augmented state vector, \hat{x}_{k|k-1}, is obtained according to Equation (4) presented below.

$${\hat{x}}_{k \vert k - 1} = {\hat{f}}_{k - 1} \qquad ( Eq . 4 )$$

In Equation (4), \hat{f}ₖ is given by Equation (5):

$${\hat{f}}_{k} {=}^{Δ} 𝔼 [ {f}_{k} ( {\hat{x}}_{k \vert k} ) ] \qquad ( Eq . 5 )$$

Using the biased initial estimate of the augmented state and measured quantities, the input vector is predicted by adopting the load gain matrix Mₖ as follows:

$${\hat{d}}_{k - 1} = {M}_{k} ( {y}_{k} - {C}_{k} {\hat{x}}_{k \vert k - 1} ) \qquad ( Eq . 6 )$$

In one example, input prediction occurs via an unbiased estimation of the augmented state vector, \hat{x}_{k|k} according to Equation (7):

$${\hat{x}}_{k \vert k} = {\hat{x}}_{k \vert k - 1} + {G}_{k - 1} {\hat{d}}_{k - 1} \qquad ( Eq . 7 )$$

State estimation can then be completed via Equation (8) below, in which the unbiased augmented state estimate, \hat{x}_{k|k}, is added to an observation innovation term, yₖ−Cₖ\hat{x}_{k|k}, is multiplied by a gain matrix, Kₖ. The gain matrix, Kₖ, is derived below.

$${\hat{x}}_{k} = {\hat{x}}_{k \vert k} + {K}_{k} ( {y}_{k} - {C}_{k} {\hat{x}}_{k \vert k} ) \qquad ( Eq . 8 )$$

c. Error Propagation

According to certain examples, to quantify prediction uncertainty and determine optimal gains with respect to the linearized system, errors are propagated through the filter estimation process. In some example, a first order hold linearization of the transition function fₖ₋₁(x) about \hat{x}_{k-1|k-1} is used. The linearization can be achieved through a first order Taylor series expansion, and by adopting the Jacobian of fₖ₋₁(x) as follows:

$${f}_{k - 1} ( x ) \approx {f}_{k - 1} ( {\hat{x}}_{k - 1 \vert k - 1} ) + \frac{\partial {f}_{k - 1}}{\partial x} {\vert}_{x = {\hat{x}}_{k - 1 \vert k - 1}} ( x - {\hat{x}}_{k - 1 \vert k - 1} ) \qquad ( Eq . 9 )$$

As a direct result of Equation (9), the mean of the biased augmented state estimate, \hat{x}_{k|k-1}, becomes expressed as Equation 10:

$${\hat{x}}_{k \vert k - 1} = {f}_{k - 1} ( {\hat{x}}_{k - 1 \vert k - 1} ) \qquad ( Eq . 10 )$$

The estimation error, \hat{x}_{k|k} by \tilde{x}ₖ, can be denoted as follows:

$${\tilde{x}}_{k} {=}^{Δ} {x}_{k} - {\hat{x}}_{k \vert k} \qquad ( Eq . 11 )$$

According to certain examples, the innovation term (yₖ−Cₖ\hat{x}_{k|k}) in the load estimation set forth in Equation (6) can be expressed in terms of the augmented state estimation error, modeling error, and the observation noise using Equation (12):

$${y}_{k} - {C}_{k} {\hat{x}}_{k \vert k - 1} = {y}_{k} - {C}_{k} {f}_{k - 1} ( {\hat{x}}_{k - 1 \vert k - 1} ) = {C}_{k} {f}_{k - 1} ( {\hat{x}}_{k - 1 \vert k - 1} ) + {C}_{k} \frac{\partial {f}_{k - 1}}{\partial x} {\vert}_{x = {\hat{x}}_{k - 1 \vert k - 1}} {\hat{x}}_{k - 1} + {C}_{k} {G}_{k - 1} {d}_{k - 1} + {C}_{k} {w}_{k - 1} + {v}_{k} - {C}_{k} {f}_{k - 1} ( {\hat{x}}_{k - 1 \vert k - 1} ) = {C}_{k} {G}_{k - 1} {d}_{k - 1} + {ε}_{k} \qquad ( Eq . 12 )$$

In Equation (12), the error term, Ek, in given by Equation (13):

$${ε}_{k} = {C}_{k} ( \frac{\partial {f}_{k - 1}}{\partial x} {\vert}_{x = {\hat{x}}_{k - 1 \vert k - 1}} {\tilde{x}}_{k - 1} + {w}_{k - 1} ) + {v}_{k} \qquad ( Eq . 13 )$$

As the vectors, \tilde{x}ₖ₋₁, wₖ₋₁, and vₖ are zero mean, it follows that:

$$𝔼 [ {ε}_{k} ] = 0 \qquad ( Eq . 14 )$$

A direct result from Equations (12) and (14) is that the innovation term, yₖ−Cₖ\hat{x}_{k|k}, is an unbiased estimate of CₖGₖ₋₁dₖ₋₁. Consequently, if the relation set forth in Equation (15) below is satisfied, this renders the input estimate in Equation (6) as unbiased.

$${M}_{k} {C}_{k} {G}_{k - 1} = {I}_{m} \qquad ( Eq . 15 )$$

As described further below, an optimal gain, Mₖ, described by Equation (26) meets this unbiasedness constraint.

As, described above, according to certain examples, the estimation error of \hat{x}_{k|k} can be defined by Equation (11). The error, \tilde{x}ₖ, can be obtained by subtracting both sides of Equation (7) from xₖ, then replacing xₖ and \hat{x}_{k|k-1} with Equations (1) and (10), respectively, leading to:

$${\tilde{x}}_{k} = {x}_{k} - {\hat{x}}_{k \vert k - 1} - {G}_{k - 1} {\hat{d}}_{k - 1} = {f}_{k - 1} ( {x}_{k - 1} ) + {G}_{k - 1} {d}_{k - 1} + {w}_{k - 1} - {f}_{k - 1} ( {\hat{x}}_{k - 1 \vert k - 1} ) - {G}_{k - 1} {\hat{d}}_{k - 1} \qquad ( Eq . 16 )$$

By introducing Equation (12) into Equation (6) and substituting the resulting expression for \hat{d}ₖ₋₁ in Equation (16), one arrives at Equation (17):

$${\tilde{x}}_{k} = {f}_{k - 1} ( {x}_{k - 1} ) + {G}_{k - 1} {d}_{k - 1} + {w}_{k - 1} - {f}_{k - 1} ( {\hat{x}}_{k - 1 \vert k - 1} ) - {G}_{k - 1} {M}_{k} ( {C}_{k} {G}_{k - 1} {d}_{k - 1} + {ε}_{k} ) \qquad ( Eq . 17 )$$

By considering Equations (9), (11), and (15), the expression in Equation (17) can be converted into Equation (18), which shows that \hat{x}_{k|k} is unbiased given the unbiased estimate, \hat{x}_{k-1|k-1}.

$${\tilde{x}}_{k} = {f}_{k - 1} ( {\hat{x}}_{k - 1 \vert k - 1} ) + \frac{\partial {f}_{k - 1}}{\partial x} {\vert}_{x = {\hat{x}}_{k - 1 \vert k - 1}} ( {x}_{k} - {\hat{x}}_{k - 1 \vert k - 1} ) + {G}_{k - 1} {d}_{k - 1} + {w}_{k - 1} - {f}_{k - 1} ( {\hat{x}}_{k - 1 \vert k - 1} ) - {G}_{k - 1} {d}_{k - 1} - {G}_{k - 1} {M}_{k} {ε}_{k} = \frac{\partial {f}_{k - 1}}{\partial x} {\vert}_{x = {\hat{x}}_{k - 1 \vert k - 1}} {\tilde{x}}_{k - 1} - {G}_{k - 1} {M}_{k} {ε}_{k} + {w}_{k - 1} \qquad ( Eq . 18 )$$

Accordingly, the augmented state estimate error for Equation (8) can be obtained by subtracting both sides of Equation (8) from xₖ and replacing Equations (2) and (18) as follows:

$${\tilde{x}}_{k} = {x}_{k} - {\hat{x}}_{k \vert k} - {K}_{k} ( {y}_{k} - {C}_{k} {\hat{x}}_{k \vert k} ) = {\tilde{x}}_{k} - {K}_{k} ( {C}_{k} {x}_{k} + {v}_{k} - {C}_{k} {\hat{x}}_{k \vert k - 1} ) = {\tilde{x}}_{k} - {K}_{k} ( {C}_{k} {\tilde{x}}_{k} + {v}_{k} ) \qquad ( Eq . 19 )$$

d. Covariance Propagation

After deriving the estimation errors, as described above, the corresponding covariance matrices can be derived. In one example, the error covariance for the innovation term, yₖ−Cₖ\hat{x}_{k|k}, namely, \tilde{ε}ₖ, is given by Equation (20):

$${Λ}_{k} {=}^{Δ} 𝔼 [ {ε}_{k} {ε}_{k}^{T} ] = {C}_{k} ( {Ω}_{k} + {Q}_{k - 1} ) {C}_{k}^{T} + {R}_{k} \qquad ( Eq . 20 )$$

In Equation (20), Ωₖ is given by Equation (21):

$${Ω}_{k} {=}^{Δ} ( \frac{\partial {f}_{k - 1}}{\partial x} {\vert}_{x = {\hat{x}}_{k - 1 \vert k - 1}} ) {{P}_{k - 1} ( \frac{\partial {f}_{k - 1}}{\partial x} {\vert}_{x = {\hat{x}}_{k - 1 \vert k - 1}} )}^{T} \qquad ( Eq . 21 )$$

The error covariance for the unbiased augmented state estimate, \hat{x}_{k|k}, is given by Equation (22):

$${𝒫}_{k} {=}^{Δ} 𝔼 [ {\tilde{x}}_{k} {\tilde{x}}_{k}^{T} ] = {Ω}_{k} + {Q}_{k - 1} + {G}_{k - 1} {M}_{k} {Λ}_{k} {M}_{k}^{T} {G}_{k - 1}^{T} - {G}_{k - 1} {M}_{k} {C}_{k} ( {Ω}_{k} + {Q}_{k - 1} ) - ( {Ω}_{k} + {Q}_{k - 1} ) {C}_{k}^{T} {M}_{k}^{T} {G}_{k - 1}^{T} \qquad ( Eq . 22 )$$

Furthermore, the covariance pertaining to the augmented state estimation error can be derived as:

$${P}_{k} {=}^{Δ} 𝔼 [ {\tilde{x}}_{k} {\tilde{x}}_{k}^{T} ] = {K}_{k} {Ψ}_{k} {K}_{k}^{T} - {Υ}_{k} {K}_{k}^{T} - {K}_{k} {Υ}_{k}^{T} + {𝒫}_{k} \qquad ( Eq . 23 )$$

### In Equation (23):

$${Y}_{k} {=}^{Δ} {𝒫}_{k} {C}_{k}^{T} - {G}_{k - 1} {M}_{k} {R}_{k} ; \qquad ( Eq . 24 )$$

$$and$$

$${Ψ}_{k} {=}^{Δ} {C}_{k} {𝒫}_{k} {C}_{k} - {C}_{k} {G}_{k - 1} {M}_{k} {R}_{k} - {R}_{k} {M}_{k}^{T} {G}_{k - 1}^{T} {C}_{k}^{T} + {R}_{k} \qquad ( Eq . 25 )$$

e. Optima Gains

According to certain examples, optimality is applied to linearized state space equations and therefore, while the estimator may yield accurate system estimates, it may yield globally suboptimal estimates due to the non-linear nature of the problem. The optimality term refers to an estimation whereby the expectation of the estimation error variance is minimum for the linearized system. Considering the form of Equation (12), a least squares method can be used to calculate an optimal input gain, Mₖ, for inversion of the linearized system. In some examples, the least squares can be weighted with respect to the error term, εₖ, so that the estimation error variance is at a minimum. Applying this approach, an optimal input gain can be obtained using the weight matrix Aₖ₋₁ as follows:

$${M}_{k} = {( {G}_{k - 1}^{T} {C}_{k}^{T} {Λ}_{k}^{- 1} {C}_{k} {G}_{k - 1} )}^{- 1} {G}_{k - 1}^{T} {C}_{k}^{T} {Λ}_{k}^{- 1} \qquad ( Eq . 26 )$$

In some examples, the input estimation can be denoted as set forth in Equation (27):

$${\tilde{d}}_{k} {=}^{Δ} {d}_{k} - {\hat{d}}_{k} \qquad ( Eq . 27 )$$

The input estimation error covariance, with the optimal gain given by Equation (26), is then given by Equation (28):

$${P}_{k}^{d} {=}^{Δ} 𝔼 [ {\tilde{d}}_{k} {\tilde{d}}_{k}^{T} ] = {( {C}_{k} {G}_{k - 1} {Λ}_{k}^{- 1} {G}_{K - 1}^{T} {C}_{k}^{T} )}^{- 1} \qquad ( Eq . 28 )$$

In some examples, the optimal augmented state gain matrix, Kₖ, is defined so that it minimizes the trace of the augmented state estimation error covariance, Pₖ. To avoid numerical issues caused by potential rank deficiency of Pₖ, the following assumption can be made:

$${K}_{k} = {\overline{𝒦}}_{k} {U}_{k}^{T} \qquad ( Eq . 29 )$$

In Equation (29), the matrix Uₖ accommodates singular vectors of Ψₖ for which the singular values are non-zero. Accordingly, the optimization problem leads to the following equation for [symbol] ₖ:

$${\overline{𝒦}}_{k} = {Y}_{k} {{U}_{k} ( {U}_{h}^{T} Ψ {U}_{k} )}^{- 1} \qquad ( Eq . 30 )$$

### Methodology

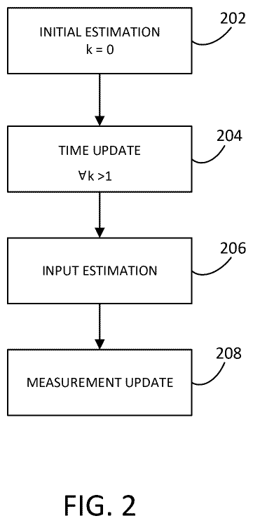

FIG. 2 is a flow diagram of a method of implementing the above-described non-linear minimum variance unbiased filtering (NL-MVU) process, according to an example. Table 1 below provides, in the form of pseudocode, an example of corresponding calculations performed at operations of the method of FIG. 2.

At operation 202, an initial estimation is performed. Operation 202 may include setting up system parameters that can be iteratively updated over time during operations 204, 206, and 208.

At operation 204, the time step is updated (e.g., k is incremented), and the calculations set forth in steps 1-3 in Table 1 may be performed.

At operation 206, input estimation is performed. For example, calculations as set forth in steps 4-7 in Table 1 may be performed.

At operation 208, a measurement update is performed. For example, the calculations described by the equations of Steps 8-14 in Table 1 may be performed. It should be noted that in Step 10 of Table 1, svd(Ψₖ) denotes performing singular value decomposition of Ψₖ, and Uₖ∈R^{p×lsvd} is selected as the matrix containing the first l_{svd} left singular vectors of Ψₖ.

Operations 204-208 can be repeated over time, for successive increments of k, to update and refine the estimated system parameters.

TABLE 1
At k = 0

Initial estimation

| | |
|---|---|
| 0. | $E [ {x}_{0} ] = {\hat{x}}_{0} ; E [ {ε}_{0} {ε}_{0}^{T} ] = {P}_{0}$ |

∀vk ≥ 1
Time update

| | |
|---|---|
| 1. | ${\hat{x}}_{k \vert k - 1} = {f}_{k - 1} ( {\hat{x}}_{k - 1 \vert k - 1} )$ |
| 2. | ${Ω}_{k} = ( \frac{\partial {f}_{k - 1}}{\partial x} {\vert}_{x = {\hat{x}}_{k - 1 \vert k - 1}} ) {{P}_{k - 1} ( \frac{\partial {f}_{k - 1}}{\partial x} {\vert}_{x = {\hat{x}}_{k - 1 \vert k - 1}} )}^{T}$ |
| 3. | ${Λ}_{k} = 𝔼 [ {ε}_{k} {ε}_{k}^{T} ] = {C}_{k} ( {Ω}_{k} + {Q}_{k - 1} ) {C}_{k}^{T} + {R}_{k}$ |

Input estimation

| | |
|---|---|
| 4. | ${M}_{k} = {( {G}_{k - 1}^{T} {C}_{k}^{T} {Λ}_{k}^{- 1} {C}_{k} {G}_{k - 1} )}^{- 1} {G}_{k - 1}^{T} {C}_{k}^{T} {Λ}_{k}^{- 1}$ |
| 5. | \hat{d}ₖ₋₁ = Mₖ(yₖ − Cₖ\hat{x}_{k\|k-1}) |
| 6. | \hat{x}_{k\|k} = \hat{x}_{k\|k-1} + Gₖ₋₁\hat{d}ₖ₋₁ |
| 7. | ${𝒫}_{k} {=}^{Δ} {Ω}_{k} + {Q}_{k - 1} + {G}_{k - 1} {M}_{k} {Λ}_{k} {M}_{k}^{T} {G}_{k - 1}^{T} - {G}_{k - 1} {M}_{k} {C}_{k} ( {Ω}_{k} +$ |
| | ${Q}_{k - 1} ) - ( {Ω}_{k} + {Q}_{k - 1} ) {C}_{k}^{T} {M}_{k}^{T} {G}_{k - 1}^{T}$ |

Measurement update

| | |
|---|---|
| 8. | ${Υ}_{k} {=}^{Δ} {𝒫}_{k} {C}_{k}^{T} - {G}_{k - 1} {M}_{k} {R}_{k}$ |
| 9. | ${Ψ}_{k} {=}^{Δ} {C}_{k} {𝒫}_{k} {C}_{k}^{T} - {C}_{k} {G}_{k - 1} {M}_{k} {R}_{k} - {R}_{k} {M}_{k}^{T} {G}_{k - 1}^{T} {C}_{k}^{T} + {R}_{k}$ |
| 10. | [UΣV^{T}] = svd (Ψₖ) |
| 11. | ${\overline{𝒦}}_{k} = {Υ}_{k} {{U}_{k} ( {U}_{k}^{T} Ψ {U}_{k} )}^{- 1}$ |
| 12. | ${K}_{k} = {\overline{𝒦}}_{k} {U}_{k}^{T}$ |
| 13. | ${P}_{k} {=}^{Δ} {K}_{k} {Ψ}_{k} {K}_{k}^{T} - {Υ}_{k} {K}_{k}^{T} - {K}_{k} {Υ}_{k}^{T} + {𝒫}_{k}$ |
| 14. | \hat{x}ₖ = \hat{x}_{k\|k} + Kₖ(yₖ − Cₖ\hat{x}_{k\|k}) |

As described above, the non-linear MVU filtering approach described herein can be applied to model structures, such as buildings, bridges, and/or other structural systems. In some such examples, the state vector may represent system displacements and/or velocities, modeling how the structure may respond (e.g., shift) in response to input data that represents loads and/or forces on the structure. According to certain examples, the non-linear MVU filter described herein can be configured to operate on input data derived from images using computer vision techniques. Using this approach, direct measurements of a structure being modelled and/or evaluated can be avoided.

### Structural Example

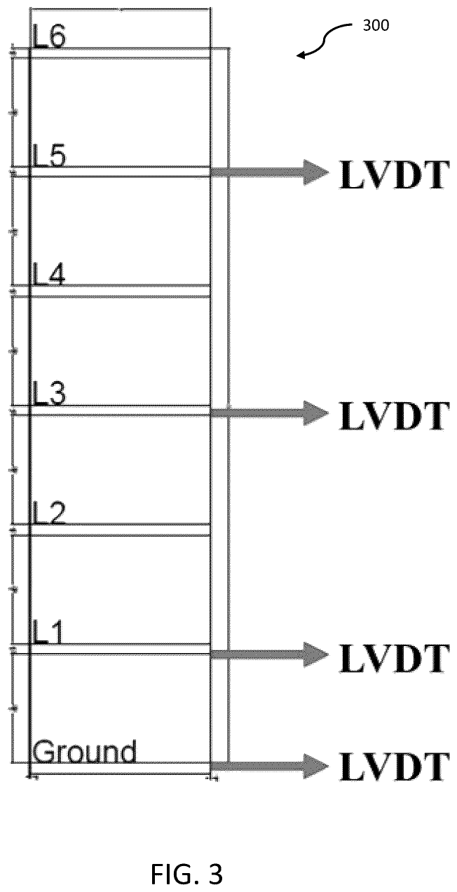

The following describes an example of applying the above-discussed techniques, system, and methodology to digital twinning of a test structure representing a multi-story building (the “test building”). A diagram of the test building is illustrated in FIG. 3. This example describes simulated experiments and tests performed using a reduced-scale laboratory model of the test building. In this example, computer vision techniques were applied to obtain the measurement data used. The example described herein demonstrates that the above-described non-linear extension of an MVU filter can be effectively used for digital twinning of systems without direct feedthrough.

Equation (31) below describes the second order ordinary differential equation for a dynamical system.

$$M \ddot{u} + C ( θ ) \dot{u} + K ( θ ) u = {S}_{p} d \qquad ( Eq . 31 )$$

In Equation (31), u∈ [symbol] ^{N}^{_{DOF}} denote the displacement vector of the system and the dots denote first-time and second-time derivatives, respectively. M, C, K∈ [symbol] ^{N}^{_{DOF×}}^{N}^{_{DOF}} denote system mass, damping and stiffness matrices, respectively, and θ∈ [symbol] ^{N}^{_{θ}}, denote the parameter vector containing inter-story stiffness coefficient for each degree of freedom (DOF). The input vector is represented by d∈ [symbol] ^{m}, and Sₚ∈ [symbol] ^{N}^{_{DOF×m}} is a mapping matrix between input vector elements and specific system degrees of freedom.

In this example, the state vector, X∈ [symbol] ^{N}^{ₛ}, is a column vector containing system displacements and velocities, and is given by Equation (32):

$$x = \{ \begin{matrix}u \\ \dot{u}\end{matrix} \} \qquad ( Eq . 32 )$$

Accordingly, the time derivate of x is:

$$\dot{x} = \{ \begin{matrix}\dot{u} \\ \ddot{u}\end{matrix} \} \qquad ( Eq . 33 )$$

Using definitions from Equations 31-33, the state space matrices can be linked to the structural dynamics problem at hand. For the state transition equation:

$${A}_{c} = [ \begin{matrix}0 & I \\ - {M}^{- 1} K ( θ ) & - {M}^{- 1} C ( θ )\end{matrix} ] \qquad ( Eq . 34 )$$

$$B = [ \begin{matrix}0 \\ {M}^{- 1} {S}_{p}\end{matrix} ] \qquad ( Eq . 35 )$$

To obtain Aₖ and Gₖ, a zero-order hold assumption may be made to discretize the state space equation in time, as shown in Equations. (36) and (37):

$${A}_{k} = exp ( {A}_{c} Δ t ) \qquad ( Eq . 36 )$$

$${G}_{k} = [ {A}_{k} - I ] {A}_{c}^{- 1} B \qquad ( Eq . 37 )$$

In the case where the observation vector yₖ is composed only by displacements and velocities of the system, the observation matrix Cₖ is given by Equation (38):

$${C}_{k} = [ \begin{matrix}{S}_{d} & 0 \\ 0 & {S}_{v}\end{matrix} ] \qquad ( Eq . 38 )$$

In Equation (38), S_{d}∈ [symbol] ^{N}^{_{d×dof}} and Sᵥ∈ [symbol] ^{N}^{_{v×dof}}, respectively denote observed displacement and velocity matrices. In the case of the experimental test described below, m=2 dof, and Cₖ∈ [symbol] ^{m×2dof} is an identity matrix. However, in other examples, m may have a different value and the observation matrix Cₖ may take a different form.

When system parameters are to be estimated, the state vector xₖ is augmented with those parameters, such that the augmented state,

$${x}_{k}^{a} ,$$

vector adopts the form given in Equation (39):

$${x}_{k}^{a} = {\{ \begin{matrix}{u}_{{N}_{dof}} \\ {\dot{u}}_{{N}_{dof}} \\ {θ}_{{N}_{θ}}\end{matrix} \}}_{{N}_{s}} \qquad ( Eq . 39 )$$

### In Equation (39),

$${N}_{s} = 2 {N}_{dof} + {N}_{θ}$$

For this example, to account for the augmented state vector, the state and control matrix can be accommodated as shown in Equations (40) and (41):

$${A}_{k}^{a} = {[ \begin{matrix}{A}_{k} & {0}_{2 {N}_{dof} \times {N}_{θ}} \\ {0}_{{N}_{θ} \times 2 {N}_{dof}} & {I}_{{N}_{θ} \times {N}_{θ}}\end{matrix} ]}_{{N}_{θ} \times {N}_{s}} \qquad ( Eq . 40 )$$

$${G}_{k}^{a} = {[ \begin{matrix}{G}_{k} \\ {0}_{{N}_{θ} \times {N}_{θ}}\end{matrix} ]}_{{N}_{s} \times {N}_{θ}} \qquad ( Eq . 41 )$$

As described above, in this example, elements of the parameter vector θ∈ [symbol] ^{N}^{_{θ}} a correspond to inter-story stiffness coefficients, simplifying the Jacobian calculation. For notational convenience, elements of the parameter vector θ are defined as kᵢ. Letting K₀ be the initial stiffness matrix from Equation (31), the partial derivative of K₀ with respect to any given k₁ stiffness parameter is given by the following:

$$\frac{\partial {K}_{0}}{\partial {k}_{i}} = {[ \begin{matrix}0 & … & … & … & 0 \\ ⋮ & ⋱ & … & … & ⋮ \\ 0 & … & {1}_{i , i} & - {1}_{i , i + 1} & 0 \\ ⋮ & … & - {1}_{i + 1 , i} & ⋱ & ⋮ \\ 0 & … & … & … & 0\end{matrix} ]}_{{N}_{θ} \times {N}_{θ}} \qquad ( Eq . 42 )$$

Neglecting the stiffness matrix contribution to system damping, the partial derivative of the state matrix with respect to the stiffness parameter yields:

$$\frac{\partial {A}_{k}}{\partial {k}_{i}} = {[ \begin{matrix}0 & 0 \\ - {M}^{- 1} \frac{\partial {K}_{0}}{\partial {k}_{i}} & 0\end{matrix} ]}_{2 {N}_{dof} \times 2 {N}_{dof}} \qquad ( Eq . 43 )$$

The Jacobian can be calculated as follows, considering the system matrix

$${A}_{k}^{a}$$

set forth in Equation (40) and the state vector as shown in Equation (39). In this case

$${A}_{k}^{a} {x}_{k}^{a}$$

yields a function of the parameters θ, f(θ) such that:

$$f ( θ ) = {A}_{k}^{a} {x}_{k}^{a} = [ \begin{matrix}{A}_{k} [ \begin{matrix}u \\ \dot{u}\end{matrix} ] \\ θ\end{matrix} ] \qquad ( Eq . 44 )$$

The Jacobian matrix of f(θ),

$${A}_{k}^{a Jacobian} = \partial f ( θ ) / \partial {x}^{a} ,$$

is then given by:

$${A}_{k}^{a Jacobian} = {[ \begin{matrix}{A}_{k} & {J}_{k} \\ 0 & I\end{matrix} ]}_{{N}_{s} \times {N}_{s}} \qquad ( Eq . 45 )$$

Following the same zero-order hold discretization process as for the state and input matrices, and noticing that Aₖ is a composite function, the discretization of the derivative of the system can be performed as follows:

Let h be a composite function of f and g, such that h is given by Equation (46):

$$h = f ( g ( x ) ) \qquad ( Eq . 46 )$$

Then, the derivative of h, with respect to x reads:

$$\frac{dh}{dx} = \frac{df}{dg} \frac{dg}{dx} \qquad ( Eq . 47 )$$

Now, if the composite function is the matrix exponential discretization described by Equation (48) below, the derivative of Aₖ (expressed in Equation (48)) with respect to the unknown stiffness parameters, kᵢ, yields Equation (49).

$${A}_{k} = exp ( Adt ) \qquad ( Eq . 48 )$$

$$\frac{{dA}_{k}}{dK} = \frac{d ( exp ( Adt ) )}{dAdt} \frac{d ( Adt )}{dK} = \sum \frac{\partial A}{\partial {k}_{i}} {dtA}_{k} \qquad ( Eq . 49 )$$

In Equation (49), Σ denotes a matrix, and not a summation.
The symbolic Jacobian, Jₖ, of the system matrix described by Equation (48) is given by the following:

$${J}_{k} = {[ \begin{matrix}\frac{\partial {A}_{k}}{\partial {k}_{1}} {\hat{x}}_{k - 1 \vert k - 1} & … & \frac{\partial {A}_{k}}{\partial {k}_{j}} {\hat{x}}_{k - 1 \vert k - 1} & … & \frac{\partial {A}_{k}}{\partial {k}_{{N}_{dof}}} {\hat{x}}_{k - 1 \vert k - 1}\end{matrix} ]}_{2 {N}_{dof} \times 2 {N}_{θ}} \qquad ( Eq . 50 )$$

### Accordingly,

$${A}_{k}^{a Jacobian}$$

is obtained by substituting Equation (50) into Equation (45).
a. Simulations

To verify the approach described above, simulations for a six degree-of-freedom shear building were performed using an example of the non-linear MVU filtering algorithm described above and presented in Table 1. A diagram of the simulated building 300 is illustrated in FIG. 3.

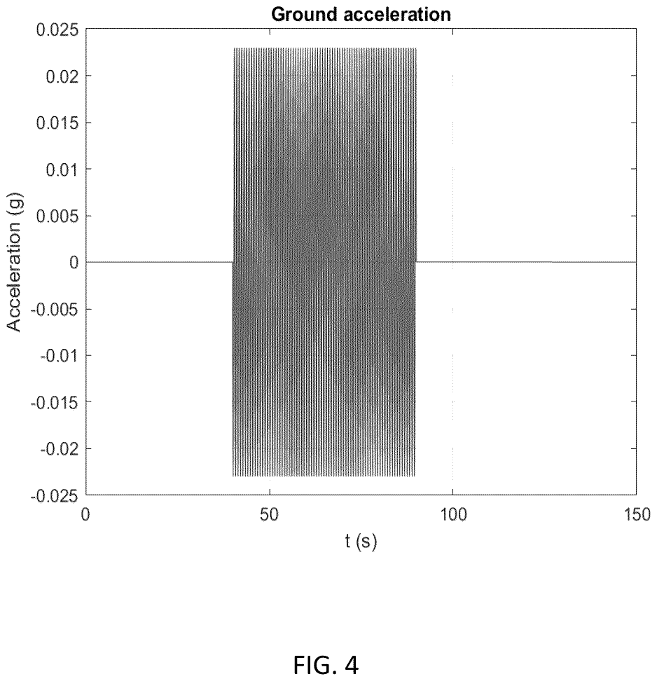

A numerical model was used to generate state space matrices, and this same model was employed for experimental validation described below. Simulated displacement and velocity observations were generated by contaminating structure response with Gaussian white noise. The added noise magnitude is expressed as a percentage of the root mean square (RMS) of the 8 structural response and was set to 1% of the RMS. The input was selected as a deterministic sinusoidal function, such that the ground displacement ug follows the shape u_{g}=A sin(w̅t), with A=2.54 mm, and w̅=1.5 Hz. The ground acceleration ü_{g} was derived by differentiation with respect to time. Simulated input was preceded and followed by 0 g ground acceleration for 40 and 60 seconds, as shown in FIG. 4.

FIG. 4 is a graph showing the ground acceleration spectrum (acceleration as a function of time) used for the simulations described herein.

Algorithm hyperparameters were selected for the input-state-parameter estimation through a tuning process. The non-linear MVU filtering algorithm was tuned using a stochastic function that minimizes the forward problem response and estimated values. Minimized residuals were calculated between the true and estimated parameters. To provide more estimation process flexibility, considering there were six parameters to be estimated (i.e., six inter-story stiffnesses), six independent hyperparameters were considered for parameter estimation. The other two hyperparameter matrices, modeling (Q) and observation (R) noise covariance matrices, were arbitrarily selected as diagonal matrices such that Q=1×10⁻⁶I, and R=1×10⁻¹I, where I is an identity matrix of appropriate order.

After tuning, the covariance matrix portion for parameter estimation (Wₚ) was set as shown in Equation (51):

$${W}_{p} = [ \begin{matrix}1 \times {10}^{- 2} & & & & & \\ & 8 \times {10}^{- 4} & & & & \\ & & 3 \times {10}^{- 3} & & & \\ & & & 3 \times {10}^{- 3} & & \\ & & & & 5 \times {10}^{- 3} & \\ & & & & & 6 \times {10}^{- 4}\end{matrix} ] \qquad ( Eq . 51 )$$

As described above, according to certain examples, computer vision can be used to obtain measurements of the system states (e.g., displacements and velocities). Accordingly, for these simulations, the observation matrix considers displacement and velocity observations from the 6 degrees of freedom of the simulated structure 300. Simulation results produced estimated states (displacement and velocity) for the fourth level of the structure. These estimations of displacement and velocity showed good agreement with “exact” response obtained from the numerical model for all three time-history stages, namely the zero-force stage, the forced vibration stage, and the free vibration stage.

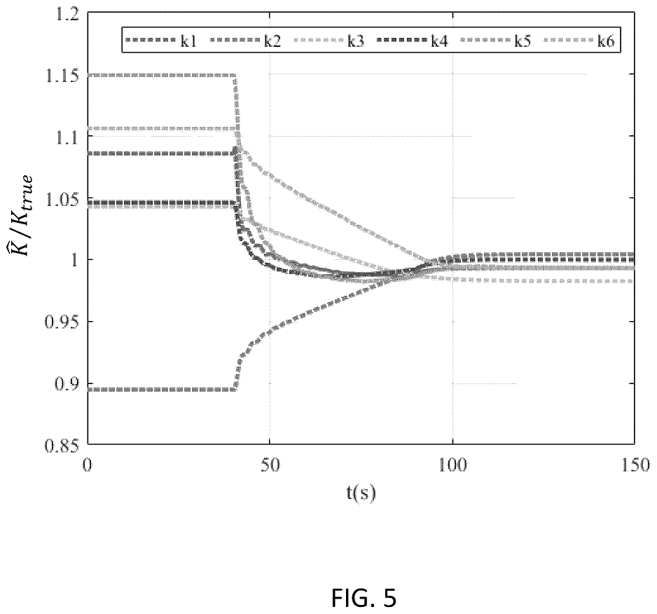

FIG. 5 illustrates system inter-story stiffness estimated parameters. Estimated values (\hat{K}) are normalized by true nominal values (Kₜᵣᵤₑ) used during generation of simulated observations. The initial selection for the estimated values employed in the augmented portion of the state vector for the initialization of the non-linear MVU filtering algorithm (x₀) was deviated randomly from the true value by approximately −10% to +15%. It was observed that the non-linear MVU filtering algorithm successfully recovered true values for all six estimated parameters (k₁-k₆). Importantly, convergence to the true value occurred during forced vibration and by the time free vibration was triggered the non-linear MVU filtering algorithm had already converged and values varied by no more than 1%. Thus, these simulations demonstrated that the non-linear MVU filtering approach described herein can be effectively used for modelling, or digital twinning, of structures without direct feedthrough.

b. Experimental Validation

To validate the methodology described herein, a six-story laboratory-scale version of the 6-DOF shear building illustrated in FIG. 3 was constructed (the “test building”). The test building was subjected to ground excitation using a linear 1-DOF shake table. An aluminum frame was placed on the shake table adjacent to the structure to measure floor level lateral displacements using an LVDT system. Four LVDTs were positioned at the ground level and at DOFs 1, 3, and 5, respectively as shown in FIG. 3. These LVDTs were used to obtain true measurements to be compared with the estimates output by the non-linear MVU filtering algorithm.

The main lateral resisting system of the test building included four columns made of A53 structural steel, each having a 1.75×⅛ in² (44.45×3.175 mm²) rectangular cross section. The story height was uniform at 10.97 in (278.6 mm). Floor slab material was Aluminum-6061 alloy, and each slab weighed 20.5 kgf. Considering these parameters, a nominal column weight of 7850 kgf/m³, and assigning proportional column's mass to each DOF by tributary area, the natural frequency of the test building was calculated to be 0.544 seconds.

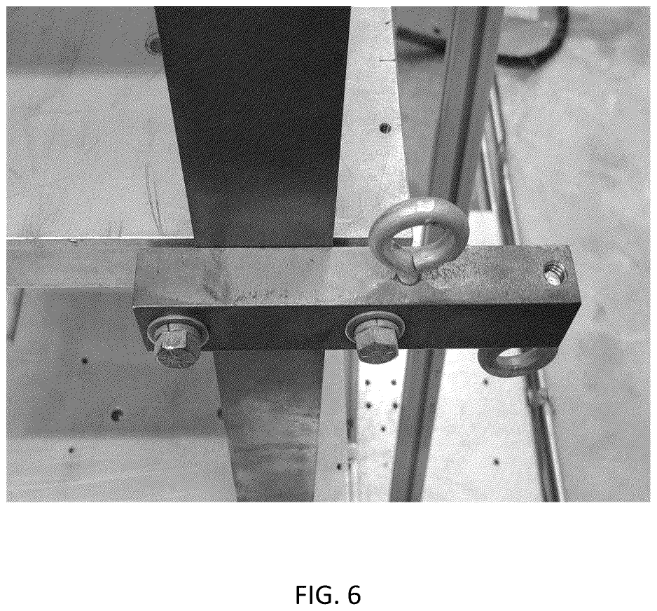

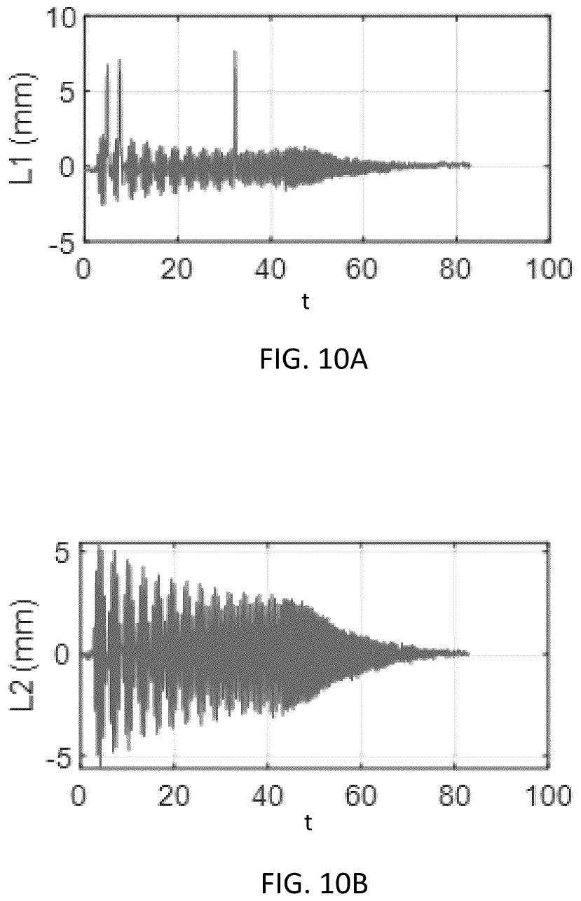

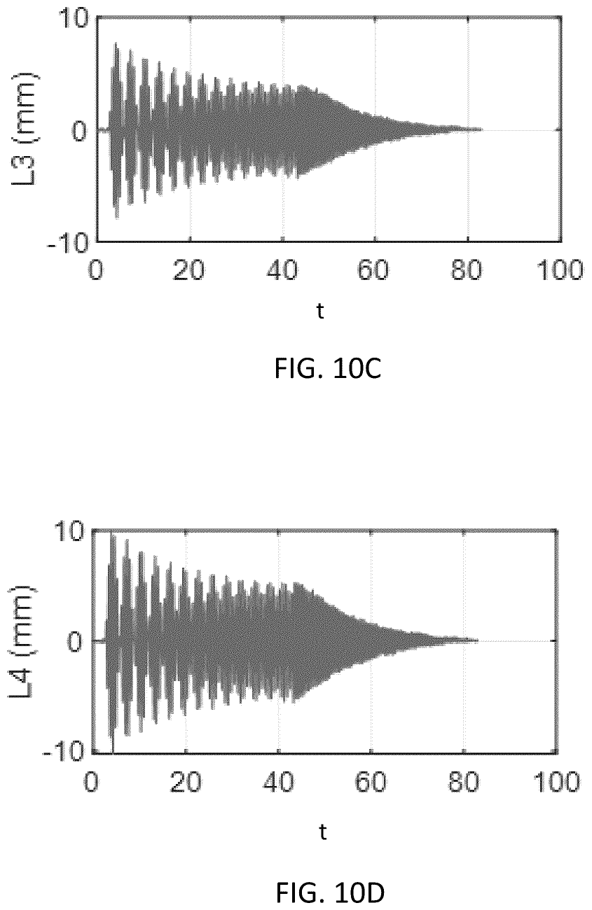

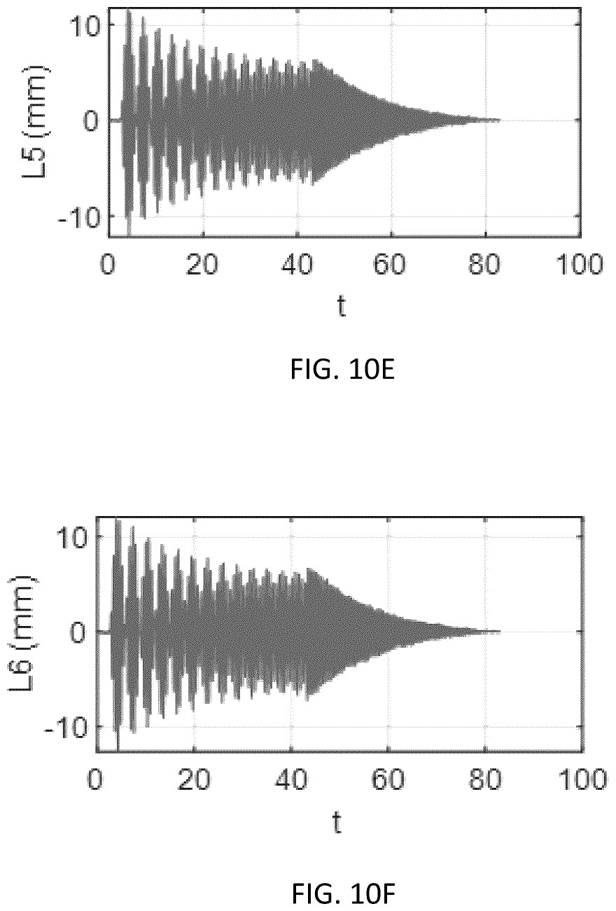

A typical bolted connection for the test building is shown in FIG. 6. The level of torque at these connections was not verified until the experiment was carried out. As can be clearly observed in FIGS. 10A-F, during free vibration stage, motion decay did not follow a smooth negative exponential curve. It is suspected that limited contact forces between the connected members released internal energy and generated multiple non-linearities within the structure of the test building.

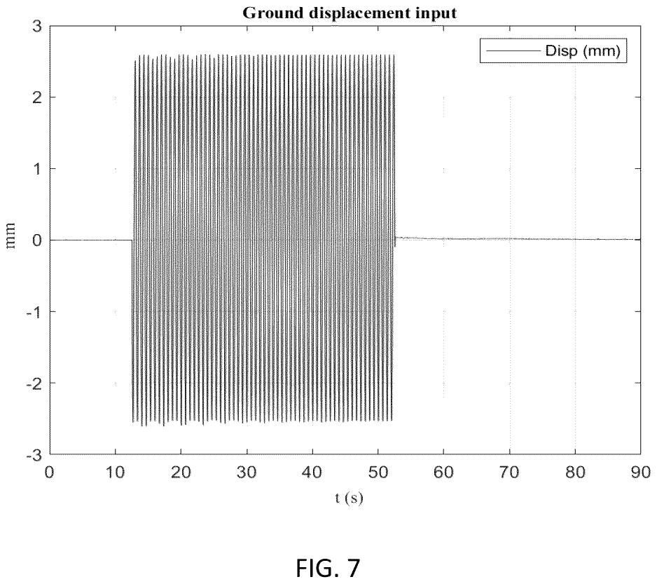

The shake table used the same sinusoidal input from the simulations described above for base excitation, with u_{g}=2.54 mm sin*(1.5×2π×t). True output was obtained using the LVDT at ground level (FIG. 7).

Displacement measurements for all floors were obtained through computer vision, using a single video recording from a cell phone camera. For the experiment described herein, the camera recorded a video at a resolution of 2160×3840 pixels at 59 frames per second to capture the dynamic response of the test building. The video was analyzed using computer vision processes to extract displacement time histories at each story of the test structure. The origin at the top-left corner of the video frame was set as a reference point and the view window was calibrated to match pixel dimensions with the actual dimensions of the structure. A distance of 0.4572 m (18 inches) between two ends of a slab was used for calibration. Brightness and contrast were adjusted to clearly identify small features within the test building that remained visible throughout the video. Rectangular feature boxes were placed on each floor of the test building, and the option to track the movement of these features based on the video's motion was enabled. The displacement data was then exported to a plain text file to feed the non-linear MVU filtering algorithm.

Computer vision observations were obtained through MATLAB code, and validated against commercially available software with feature-tracking capabilities. Obtained observations in both cases were equivalent, and accurate with sub-millimeter precision when compared to LVDT measurements.

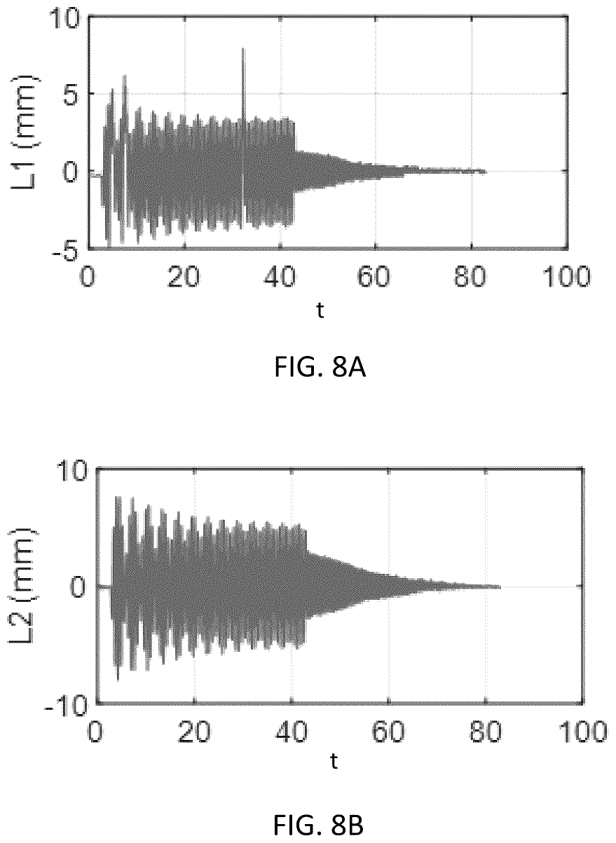

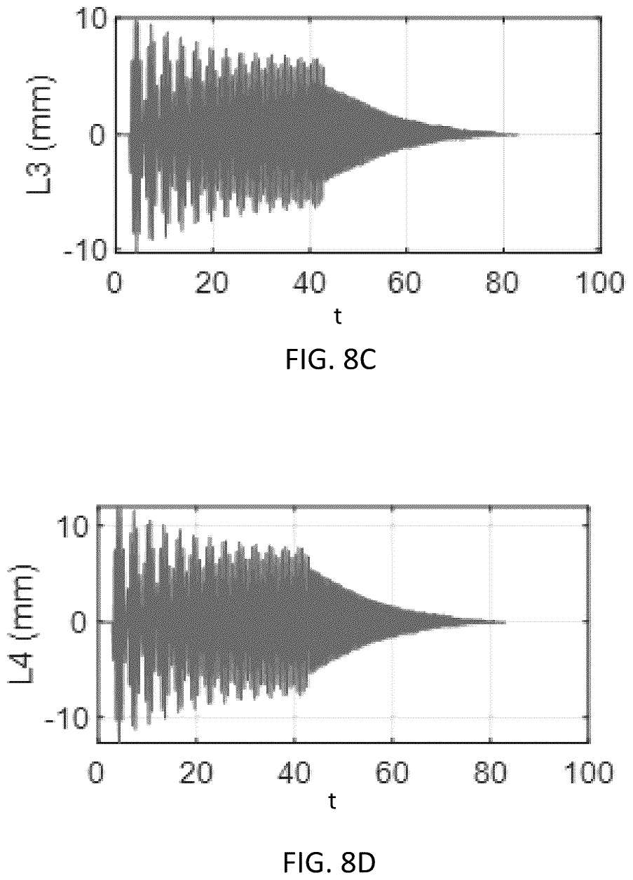

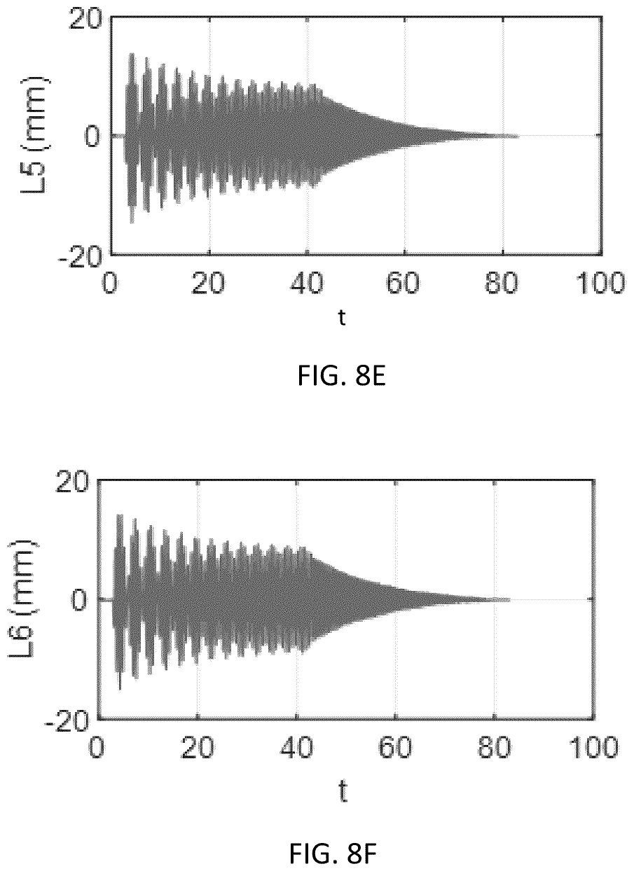

FIGS. 8A-F illustrate absolute displacement measurements, represented as time histories (e.g., displacements recorded over time), extracted from the video using computer vision software for each of the six stories (L1-L6) of the test building.

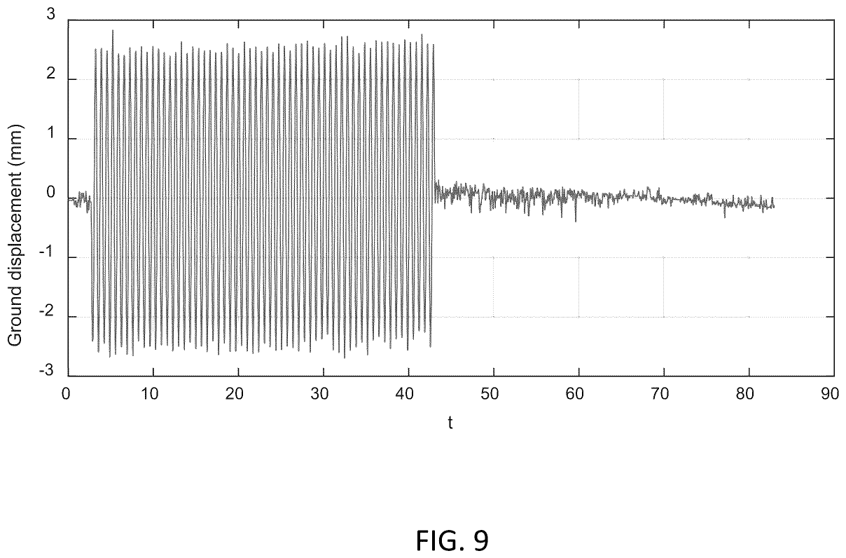

After obtaining the absolute displacements for each level, the ground displacement for the shake table was measured using a similar methodology. The results for ground displacement are presented in FIG. 9. With both the absolute displacement and the ground displacement of the shake table, the relative displacement of every level/floor of the test building with respect to the ground can be calculated. FIGS. 10A-F illustrate calculated relative displacement of each floor, respectively, of the test building.

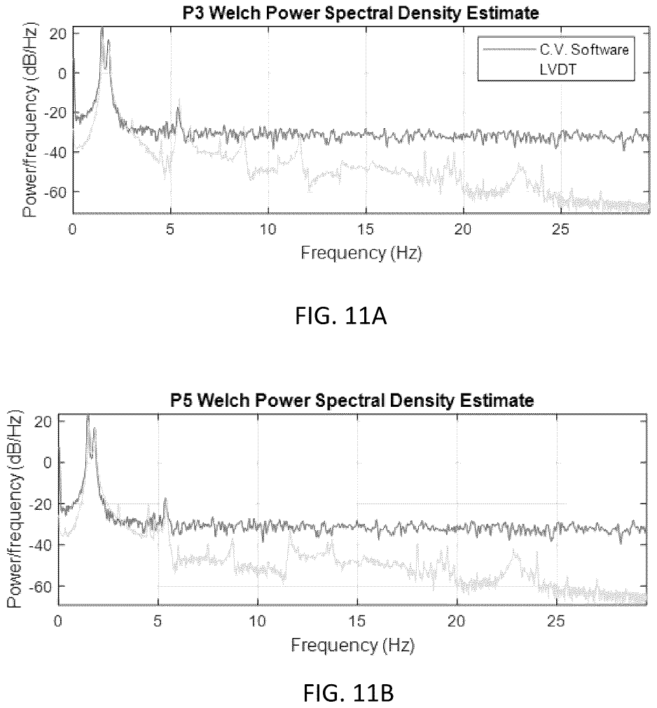

To verify the quality of the results, obtained results for the third and fifth floors of the test building were compared against true measurements obtained using the LVDTs placed on those floors. FIGS. 11A and 11B illustrate comparisons in the frequency domain, for the third and fifth floors of the test building, respectively, of the results obtained using computer vision analysis and LVDT measurements.

From the displacement measurements, and a known, constant time-step, velocity observations can be estimated by applying time differentiation to the relative displacements.

As discussed above, the numerical model used to determine initial state-space matrices for the experimental validation was the same as that employed for the simulated experiments described above. This numerical model assumed that the floors were infinitely rigid compared to the lateral stiffness of the columns. Additionally, it was also assumed that the columns did not undergo any changes along their length and the floors could only move laterally (1 DOF per floor). In this experiment, the non-linear MVU filtering algorithm was tuned using a stochastic process by minimizing residuals between estimated stiffness parameters and nominal true values. Since the estimated parameters were inter-story stiffnesses, they represented nonlinear combinations of other parameters, (i.e., element geometry, number of elements, and material properties). The hyperparameters for modeling and observation error noise covariances, Q and R, were set to Q=1×10⁻⁶I, and R=1×10⁻¹I, as in the simulations described above. After minimization was performed, tuning parameters for parameter estimation portion of the noise covariance were set as shown in Equation (52):

$${W}_{p} = [ \begin{matrix}3.5 \times {10}^{- 4} & & & & & \\ & 8 \times {10}^{- 3} & & & & \\ & & 6.5 \times {10}^{- 4} & & & \\ & & & 1.2 \times {10}^{- 3} & & \\ & & & & 5 \times {10}^{- 4} & \\ & & & & & 3.5 \times {10}^{- 4}\end{matrix} ] \qquad ( Eq . 52 )$$

As described above, a single camera video was used to obtain displacement and velocity observations for all degrees of freedom of the test building and, therefore, the observation matrix (Cₖ in Eq. (2)) considered all available measurements.

For input-state-parameter estimation it was observed, for the fourth floor of the test building, that both estimated floor displacements and estimated velocities were in good agreement with respect to LVDT measurements for all stages of response. Some variation between the LVDT measurements and the results obtained from the non-linear MVU filtering algorithm could be attributed to certain aspects of the test building (such as effects caused by the bolted connections, an example of which is shown in FIG. 7) and/or the shake table. Further, some sources of error may include the type of damping selected for the numerical model. In addition, in some examples, the non-linear MVU filtering algorithm may be highly affected by measurement noise, which may impact the accuracy of the results produced.

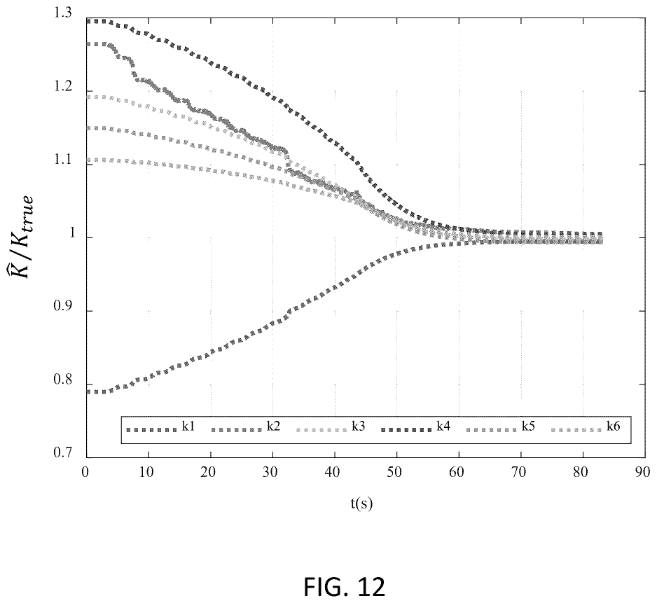

FIG. 12 illustrates normalized inter-story stiffness estimations produced by the non-linear MVU filtering algorithm for the test building. In contrast to what was observed for the simulations described above, where the parameters converged during forced vibration, experimental parameters did not converge until free vibration. The initial setting for the parameters was randomly picked within a range of −20% to +30% of the true nominal value. It was observed that by using only the computer-vision based measurements for input data, the non-linear MVU filtering algorithm could simultaneously estimate all inter-story stiffness parameters and converge to a true nominal value with less than 1% error.

Thus, through the simulations and experimental tests described herein, and using pure computer vision measurements as the sensor network, an example of a non-linear minimum variance filter approach for digital twinning has been validated. This example demonstrates the ability to provide highly accurate estimates of system parameters and unknown excitations, confirming the robustness and effectiveness of the approach described herein in real-world scenarios.

### CONCLUSION

Thus, aspects and examples provide a non-linear minimum variance unbiased filter that can be used to model systems without direct feedthrough. The techniques disclosed herein may offer a significant improvement over existing solutions by addressing at least two challenges faced by current digital twinning and structural health monitoring approaches. Unlike traditional methods, such as Kalman filters, which rely on prior knowledge of input loads or their statistical properties, examples of the non-linear minimum variance unbiased filter disclosed herein do not require a-priori information about unknown inputs. This eliminates a significant barrier in real-world applications, where load information is often unavailable or highly uncertain. Further, by extending the minimum variance unbiased filter to handle non-linear systems without a direct feedthrough matrix, the techniques described herein may be applicable to a broad range of sensor networks, including those measuring pure displacement, rotation, strain, and velocity. Some existing methods are limited to specific sensor types and/or involve extensive tuning. In contrast, the approach described herein may provide more robust and accurate state and parameter estimation across diverse systems. This flexibility makes the approach particularly effective in complex, real-world environments where existing methods may struggle to deliver reliable results. By offering a more adaptive and comprehensive solution, examples described herein may enhance the accuracy, efficiency, and applicability of digital twins for structural monitoring and other engineering fields.

Further, by using computer vision techniques to derive measurement data from images, rather than using sensors to directly measure variables such as displacement, for example, the approach can be applied to digital twinning of structures where obtaining direct measurements are difficult (e.g., sensor data may be needed from inaccessible locations on or around the structure). For example, the techniques described herein can be applied to digital twinning of complex buildings, bridges, aircrafts, ships, and other structures.

The foregoing description of examples and aspects thereof has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein. Additionally, references herein to “embodiment” or “example” mean that a particular element, structure, or characteristic described in connection with the embodiment or example can be included in at least one example of the technology described herein. The appearances of these terms in various places in the specification are not necessarily all referring to the same example, nor are separate or alternative examples mutually exclusive of other examples. As such, the examples described herein, explicitly and implicitly understood by one skilled in the art, can be combined with other examples.

### Further Examples

The following examples pertain to further embodiments, from which numerous permutations and configurations will be apparent.

Example 1 is a non-linear minimum variance unbiased filter for digital twinning applications.

Example 2 is a method of structural health monitoring, the method comprising: obtaining measurements of one or more parameters of a structure; determining a state function describing a state-space formulation of the structure, calculating the Jacobian of the state function, and applying a non-linear minimum variance filter using the state function and the Jacobian to estimate at least one of the one or more parameters of the structure based on the measurements.

Example 3 includes the method of Example 2, wherein obtaining the measurements comprises deriving the measurements from two or more images of the structure using computer vision analysis.

Example 4 includes the method of Example 3, further comprising obtaining the two or more images using at least one camera.

Example 5 is a method comprising: acquiring, with a camera, a plurality of images of a structure; deriving, from the plurality of images and by using computer vision analysis, a time-sequence of measurements of the structure to produce input data; and applying a non-linear minimum variance unbiased filter to the input data to generate an estimate of at least one parameter of the structure.

Example 6 includes the method of Example 5, wherein the time-sequence of measurements includes a time-sequence of displacement measurements; and wherein the estimate of the at least one parameter of the structure includes an estimate of a stiffness of the structure.

Example 7 includes the method of Example 6, further comprising deriving, from the time-sequence of displacement measurements, a time-sequence of velocity measurements; wherein the input data includes the time-sequence of displacement measurements and the time-sequence of velocity measurements.

Example 8 includes the method of any one of Examples 5-7, wherein applying the non-linear minimum variance unbiased filter to the input data includes: determining a state function describing a state vector of the at least one parameter as a state-space formulation of dynamics of the structure; calculating the Jacobian of the state function; and applying the non-linear minimum variance unbiased filter using the state function and the Jacobian to estimate the at least one parameter of the structure based at least in part on the time-sequence of measurements.

Example 9 includes the method of Example 8, wherein the state function includes an input vector, and wherein applying the non-linear minimum variance unbiased filter to the input data includes: obtaining a biased initial estimate of the at least one parameter of the structure; and predicting, with the filter and based on the biased initial estimate and the time-sequence of measurements, the input vector.

Example 10 includes the method of Example 9, wherein generating the estimate of the at least one parameter of the structure includes generating, with the filter, an unbiased estimate of the state vector based in part on the predicted input vector.

Example 11 includes the method of any one of Examples 5-10, wherein acquiring the plurality of images includes recording, with the camera, a video of the structure.

Example 12 is a system including the camera and a computing device, the system configured to perform the method of any one of Examples 5-11.

Example 13 is a computer program product comprising one or more non-transitory machine-readable mediums having instructions encoded thereon that when executed by at least one processor cause an estimation process using minimum variance unbiased filtering to be carried out, the estimation process comprising: obtaining a biased initial estimate of an augmented state vector corresponding to at least one parameter of a structure, the augmented state vector being described by a difference function that includes an input vector; predicting the input vector based on an observation noise function derived from measurement data for the structure; generating an unbiased estimate of the augmented state vector based on the input vector; and producing an estimate of the at least one parameter based on the unbiased estimate of the augmented state vector.

Example 14 includes the computer program product of Example 13, wherein the measurement data includes a time-sequence of displacement measurements of the structure.

Example 15 includes the computer program product of Example 14, wherein the measurement data further includes a time-sequence of velocity measurements of the structure; and wherein the estimation process further comprises deriving the time-sequence of velocity measurements from the time-sequence of displacement measurements.

Example 16 includes the computer program product of one of Examples 14 or 15, wherein the at least one parameter includes a stiffness of the structure.

Example 17 includes the computer program product of any one of Examples 14-16, wherein the estimation process further comprises: deriving the time-sequence of displacement measurements from a plurality of images of the structure using computer vision analysis.

Example 18 includes the computer program product of any one of Examples 13-17, wherein the difference function includes a non-linearity term, and wherein estimation process further comprises calculating the Jacobian of the non-linearity term.

Example 19 includes the computer program product of any one of Examples 13-18, wherein the estimation process further comprises calculating an error covariance for the unbiased estimate of the augmented state vector.

Example 20 includes the computer program product of any one of Examples 13-19, wherein predicting the input vector includes multiplying the observation noise function by a gain term; and wherein the gain term is determined by applying least squares method to the observation noise function.

Example 21 is a computing device including the at least one processor and the computer program product of any one of Examples 13-20.

Example 22 is a system comprising the computing device of Example 21 and a camera.

1. A method comprising:
acquiring, with a camera, a plurality of images of a structure;
deriving, from the plurality of images and by using computer vision analysis, a time-sequence of measurements of the structure to produce input data; and
applying a non-linear minimum variance unbiased filter to the input data to generate an estimate of at least one parameter of the structure.

2. The method of claim 1, wherein the time-sequence of measurements includes a time-sequence of displacement measurements; and
wherein the estimate of the at least one parameter of the structure includes an estimate of a stiffness of the structure.

3. The method of claim 2, further comprising:
deriving, from the time-sequence of displacement measurements, a time-sequence of velocity measurements;
wherein the input data includes the time-sequence of displacement measurements and the time-sequence of velocity measurements.

4. The method of claim 1, wherein applying the non-linear minimum variance unbiased filter to the input data includes:
determining a state function describing a state vector of the at least one parameter as a state-space formulation of dynamics of the structure;
calculating the Jacobian of the state function; and
applying the non-linear minimum variance unbiased filter using the state function and the Jacobian to estimate the at least one parameter of the structure based at least in part on the time-sequence of measurements.

5. The method of claim 4, wherein the state function includes an input vector, and wherein applying the non-linear minimum variance unbiased filter to the input data includes:
obtaining a biased initial estimate of the at least one parameter of the structure; and
predicting, with the filter and based on the biased initial estimate and the time-sequence of measurements, the input vector.

6. The method of claim 5, wherein generating the estimate of the at least one parameter of the structure includes generating, with the filter, an unbiased estimate of the state vector based in part on the predicted input vector.

7. The method of claim 1, wherein acquiring the plurality of images includes recording, with the camera, a video of the structure.

8. A computer program product comprising one or more non-transitory machine-readable mediums having instructions encoded thereon that when executed by at least one processor cause an estimation process using minimum variance unbiased filtering to be carried out, the estimation process comprising:
obtaining a biased initial estimate of an augmented state vector corresponding to at least one parameter of a structure, the augmented state vector being described by a difference function that includes an input vector;
predicting the input vector based on an observation noise function derived from measurement data for the structure;
generating an unbiased estimate of the augmented state vector based on the input vector; and
producing an estimate of the at least one parameter based on the unbiased estimate of the augmented state vector.

9. The computer program product of claim 8, wherein the measurement data includes a time-sequence of displacement measurements of the structure.

10. The computer program product of claim 9, wherein the measurement data further includes a time-sequence of velocity measurements of the structure; and
wherein the estimation process further comprises deriving the time-sequence of velocity measurements from the time-sequence of displacement measurements.

11. The computer program product of claim 9, wherein the at least one parameter includes a stiffness of the structure.

12. The computer program product of claim 9, wherein the estimation process further comprises:
deriving the time-sequence of displacement measurements from a plurality of images of the structure using computer vision analysis.

13. The computer program product of claim 8, wherein the difference function includes a non-linearity term, and wherein estimation process further comprises:
calculating the Jacobian of the non-linearity term.

14. The computer program product of claim 8, wherein the estimation process further comprises:
calculating an error covariance for the unbiased estimate of the augmented state vector.

15. The computer program product of claim 8, wherein predicting the input vector includes multiplying the observation noise function by a gain term; and
wherein the gain term is determined by applying least squares method to the observation noise function.
